(19) United States
(12) Patent Application Publication
(10) Pub. No.: US 2022/0063104 A1
(43) Pub. Date: Mar. 3, 2022

(54) CALIBRATION METHOD FOR TOOL CENTER POINT, TEACHING METHOD FOR ROBOTIC ARM AND ROBOTIC ARM SYSTEM USING THE SAME

(71) Applicant: INDUSTRIAL TECHNOLOGY RESEARCH INSTITUTE, Hsinchu (TW)

(72) Inventors: Cheng-Kai HUANG, Taichung City (TW); Yi-Ying LIN, Taichung City (TW); Bing-Cheng HSU, Hemei Township (TW); Jan-Hao CHEN, Hemei Township (TW)

(73) Assignee: INDUSTRIAL TECHNOLOGY RESEARCH INSTITUTE, Hsinchu (TW)

(21) Appl. No.: 17/230,626

(22) Filed: Apr. 14, 2021

(30) Foreign Application Priority Data
Aug. 31, 2020 (TW) 109129784

(51) Int. Cl. B25J 9/16; B25J 13/08; B25J 9/02

(52) U.S. Cl. CPC B25J 9/1692; B25J 9/1697; B25J 9/023; B25J 9/163; B25J 13/089; B25J 9/1664

(57) ABSTRACT

Firstly, a robotic arm drives a projection point of tool projected on test plane to perform relative movement relative to a reference point of a test plane. Then, conversion relationship is established according to the relative movement. Then, a tool axis vector relative to an installation surface reference coordinate system of the robotic arm is obtained. Then, calibration point information group obtaining step is performed, wherein the calibration point information group obtaining step includes: (a1) the robotic arm drives a tool center point to coincide with a reference point of the test plane and records calibration point information group; (a2) the robotic arm drives the tool to change angle of the tool; and (a3) steps (a1) and (a2) are repeated to obtain several calibration point information groups. Then, tool center point coordinate relative to the installation surface reference coordinate system is obtained according to the calibration point information groups.

This application claims the benefit of Taiwan application Serial No. 109129784, filed Aug. 31, 2020, the subject matter of which is incorporated herein by reference.

### TECHNICAL FIELD

The disclosure relates in general to a calibration method, a teaching method for robotic arm and a robotic arm system using the same, and more particularly to a calibration method for tool center point, a teaching method for robotic arm and a robotic arm system using the same.

### BACKGROUND

Along with the advancement of science and technology, the application of robotic arms has become more and more broad in various industries. Generally speaking, robotic arms are jointed-type robotic arms with multiple joints, and one end of which is provided with a tool, such as welding tools or drilling tools, etc., to perform various operations. Before the robotic arm performs operations, the position of the Tool Center Point (TCP) of the tool needs to be accurately calibrated in advance, so that controller of the robotic arm could control tool to run on a calibration path according to the TCP of the tool. However, the TCP calibration technology of the robotic arm of the prior art does have many disadvantages that need to be improved. For example, according to the TCP calibration technology of the robotic arm of the prior art, user may need to manually operate the robotic arm to calibrate the TCP of the robotic arm. Therefore, it is prone to human error and thus the TCP cannot be accurately calibrated. Conclusively, it causes low calibration accuracy, high labor cost and time cost. In addition, the current calibration method for the TCP cannot be applied to the virtual TCP.

### SUMMARY

According to an embodiment, a calibration method for tool center point is provided. The calibration method includes the following steps: step of establishing a first conversion relationship between a robotic arm reference coordinate system and a camera reference coordinate system is performed, comprising: (1) driving, by a robotic arm, a projection point of a tool axis of a tool projected on a test plane to perform a relative movement relative to a reference point of the test plane; and (2) establishing the first conversion relationship according to the relative movement; obtaining a tool axis vector relative to an installation surface reference coordinate system of the robotic arm; a calibration point information group obtaining step is performed, comprising: (a1) driving, by the robotic arm, a tool center point to coincide with the reference point of the test plane, and recording a calibration point information group of the robotic arm; (a2) driving, by the robotic arm, the tool to change an angle of the tool axis; and (a3) repeating steps (a1) and (a2) to obtain a plurality of the calibration point information groups; and a tool center point coordinate relative to the installation surface reference coordinate system obtained according to the calibration point information groups.

According to another embodiment, a teaching method for a robotic arm is provided. The teaching method includes the following steps: (d1) by using the calibration method as described above, the tool center point coordinate is obtained and driving the tool to a first position, so that the tool center point coincides with a designated point of a detection surface at the first position; (d2) the tool is translated by a translation distance to a second position; (d3) a detection angle of the tool is obtained according to the translation distance and a stroke difference of the tool center point of the tool along the tool axis; (d4) whether the detection angle meets a specification angle is determined; (d5) the tool is driven back to the first position when the detection angle does not meet the specification angle; and (d6) posture of the robotic arm is adjusted to perform steps (d2) to (d6) until the detection angle meets the specification angle.

According to an alternative embodiment, a robotic arm system includes a robotic arm and a controller. The robotic arm is configured to carry a tool, wherein the tool has a tool axis. The controller is configured to control the robotic arm to drive a projection point of a tool axis of a tool projected on a test plane to perform a relative movement relative to a reference point of the test plane; establish a first conversion relationship between a robotic arm reference coordinate system of the robotic arm and a camera reference coordinate system according to the relative movement; obtain a tool axis vector relative to an installation surface reference coordinate system of the robotic arm; perform a calibration point information group obtaining step, comprising: (a1) controlling the robotic arm to drive a tool center point to coincide with the reference point of the test plane and recording a calibration point information group of the robotic arm; (a2) controlling the robotic arm to drive the tool to change an angle of the tool axis; and (a3) repeating steps (a1) and (a2) to obtain a plurality of the calibration point information groups; and obtain a tool center point coordinate relative to the installation surface reference coordinate system according to the calibration point information groups.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a robotic arm system for calibrating the according to an embodiment of the present disclosure;

FIGS. 2A to 2D show a flowchart of the tool center point of the robotic arm system in FIG. 1 for calibrating the tool;

FIG. 3A shows a schematic diagram of the robotic arm in FIG. 1 moving relative to the reference point in space;

FIG. 3B shows a schematic diagram of the image, captured by the camera, of the projection points moving on the test plane;

FIGS. 4A to 9B show schematic diagrams of process of obtaining the tool axis vector according to an embodiment of the present disclosure;

FIG. 10A shows a schematic diagram of the second light emitted by the light source of FIG. 1 and the first light emitted by the tool along the tool axis that intersect at the tool center point;

FIG. 10B shows a schematic diagram of the projection point of the second light emitted by the light source of FIG. 10A projected on the test plane and the projection point of the first light emitted by the tool along the tool axis projected on the test plane being two separated points respectively;

FIG. 11A shows a schematic diagram of the tool center point of FIG. 10A overlapping the test plane;

FIG. 11B shows a schematic diagram of the tool center point of FIG. 11A is spaced from the reference point by projection point movement vector;

FIGS. 12A to 12B show schematic diagrams of the tool center point of FIG. 11A overlapping the reference point;

FIG. 13 shows a flowchart of an automatic teaching method for the robotic arm system according to an embodiment of the present disclosure;

FIG. 14A shows a schematic diagram of the robotic arm system of FIG. 1 performing a first detection teaching process on the tool center point; and

FIG. 14B shows a schematic diagram of the robotic arm system of FIG. 1 performing a second detection teaching process on the tool center point.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

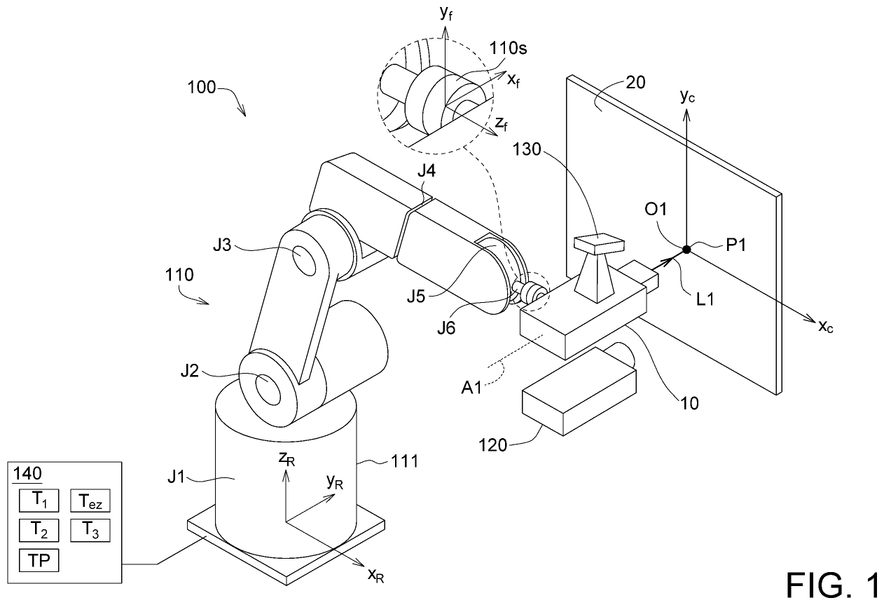

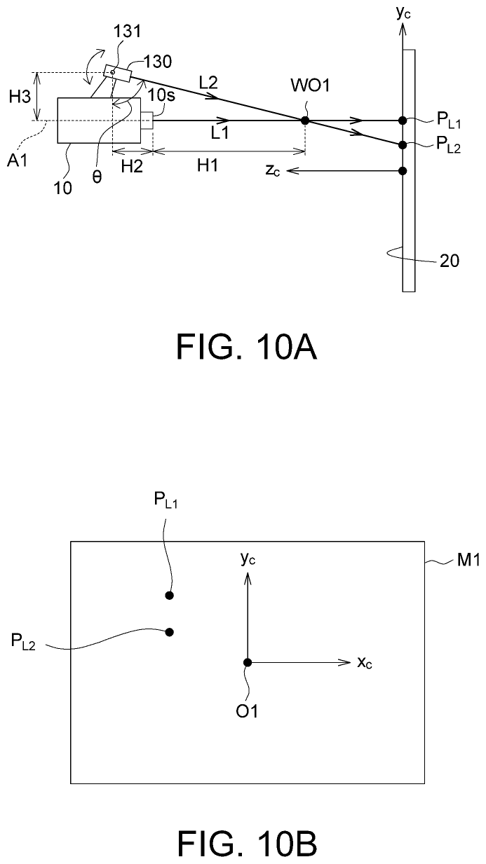

Referring to FIG. 1, FIG. 1 shows a schematic diagram of a robotic arm system for calibrating the TCP according to an embodiment of the present disclosure. The robotic arm system 100 includes a robotic arm 110, a camera 120, a light source 130 and a controller 140. The robotic arm 110 is configured to hold the tool 10, and the tool 10 has a tool axis A1. The controller 140 is configured to: (1). control the tool 10 to make a projection point P1 of the tool axis A1 of the tool 10 projected on a test plane 20 move relative to a reference point O1 of the test plane 20; (2). according to the relative movement, establish a first conversion relationship T1 between the robotic arm reference coordinate system (x_{R}-y_{R}-z_{R}) of the robotic arm 110 and a camera reference coordinate system (x_{C}-y_{C}-z_{C}) of the camera 120; (3). obtain a tool axis vector T_{ez} relative to an installation surface (or, referred to as a flange surface) reference coordinate system (x_{f}-y_{f}-z_{f}) of the robotic arm 110; (4). perform a step of obtaining calibration point information groups, including: (a1). control the robotic arm 110 to drive the tool center point WO1 (shown in FIG. 10A) to coincide with the reference point O1 of the test plane 20, and record a calibration point information group of the robotic arm 110; (a2). control the robotic arm 110 to drive the tool 10 to change the tool axis A1; and (a3). repeat steps (a1) and (a2) to obtain a number of the calibration point information groups; and (5). according to the calibration point information group, obtain a tool center point coordinate TP relative to the installation surface reference coordinate system (x_{f}-y_{f}-z_{f}).

The tool 10 is shown with a luminance meter as an example. In another embodiment, the tool 10 is, for example, a machining tool.

In the present embodiment, the test plane 20 is, for example, the surface of a physical screen. The physical screen is, for example, a transparent screen or an opaque screen. In the case of the opaque screen, the test plane 20 of the physical screen is, for example, white. However, as long as the first light L1 emitted by the tool 10 and the second light L2 emitted by the light source 130 could be clearly displayed (the second light L2 is shown in FIG. 10A), the embodiment of the disclosure does not limit the surface color of the physical screen. In the case of a transparent screen, the screen is, for example, glass or plastic. When the screen is the opaque screen, the camera 120 and the robotic arm 110 could be located on the same side of the test plane 20, as shown in FIG. 1. When the screen is the opaque screen, the camera 120 and the robotic arm 110 could be located on two opposite sides of the test plane 20, or could be located on the same side of the test plane 20. In addition, the camera 120 is directly facing the test plane 20, so that a captured image by the camera 120 is the image of the plane x_{C}-y_{C} of the camera's reference coordinate system (x_{C}-y_{C}-z_{C}).

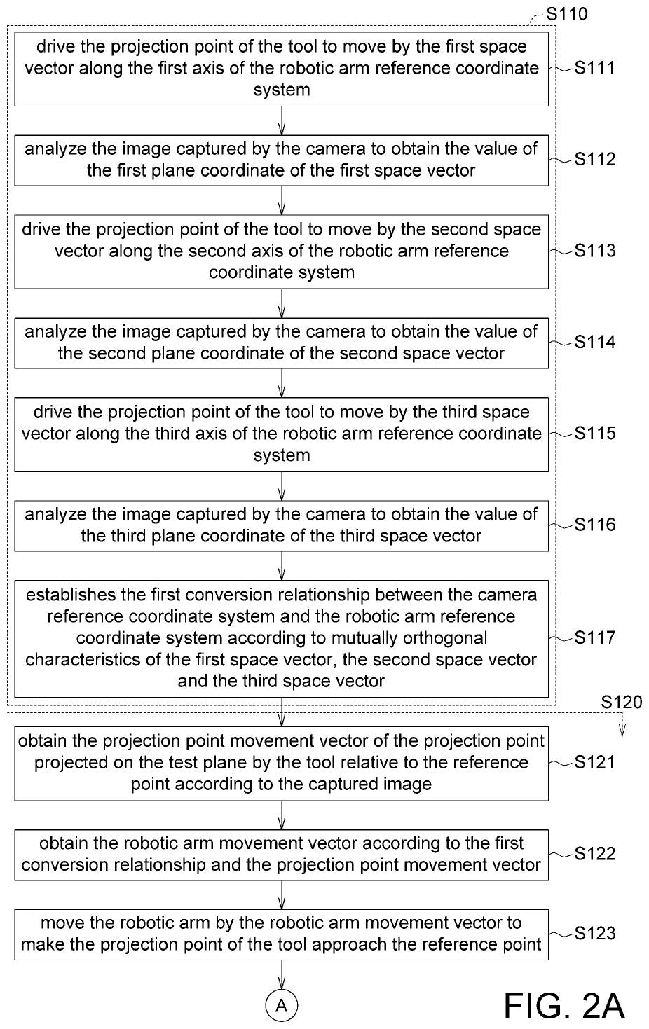

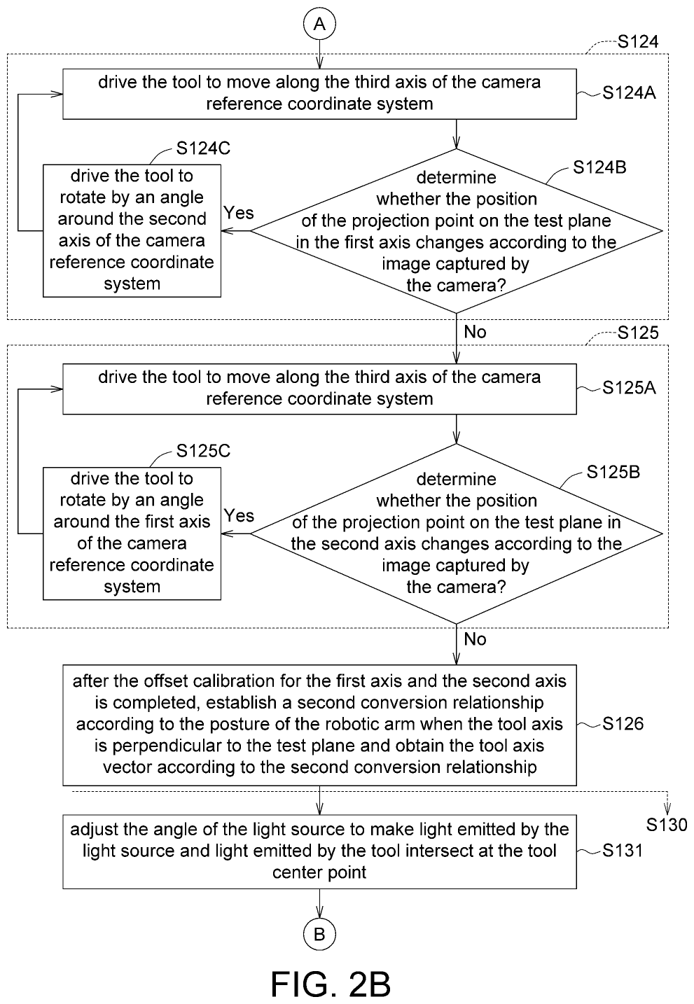

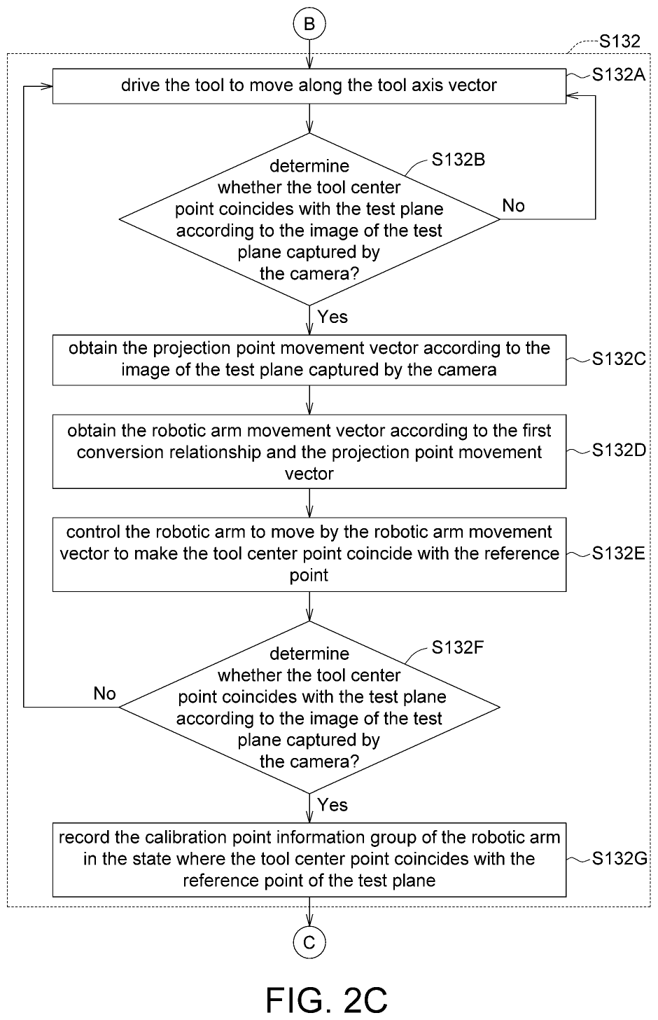

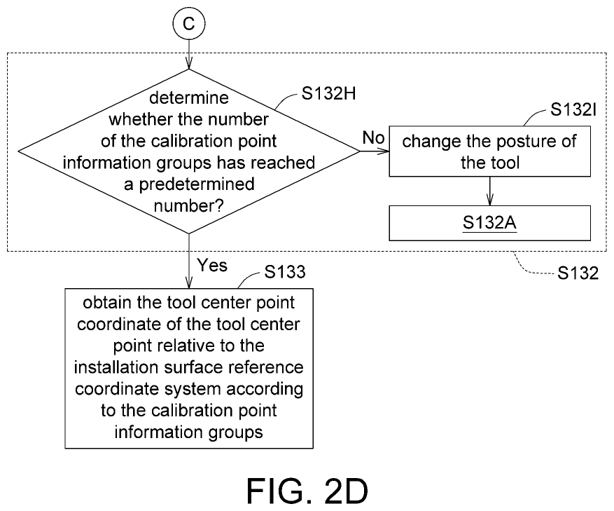

Referring to FIGS. 2A to 2D, FIGS. 2A to 2D show a flowchart of the tool center point of the robotic arm system 100 in FIG. 1 for calibrating the tool.

In step S110, the robotic arm system 100 executes the step of establishing a first conversion relationship T1 between the robotic arm reference coordinate system (x_{R}-y_{R}-z_{R}) of the robotic arm 110 and the camera's reference coordinate system (x_{C}-y_{C}-z_{C}) of the camera 120. The step S110 includes sub-steps S111 to S117. The step of establishing the first conversion relationship T1 includes the following steps: the robotic arm 110 drives the tool axis A1 of the tool 10 to project the projection point P1 on the test plane 20 relative to the reference point O1 of the test plane 20; then, the controller 140 establishes the first conversion relationship T1 between the robotic arm reference coordinate system (x_{R}-y_{R}-z_{R}) of the robotic arm 110 and the camera reference coordinate system (x_{C}-y_{C}-z_{C}) according to the relative movement.

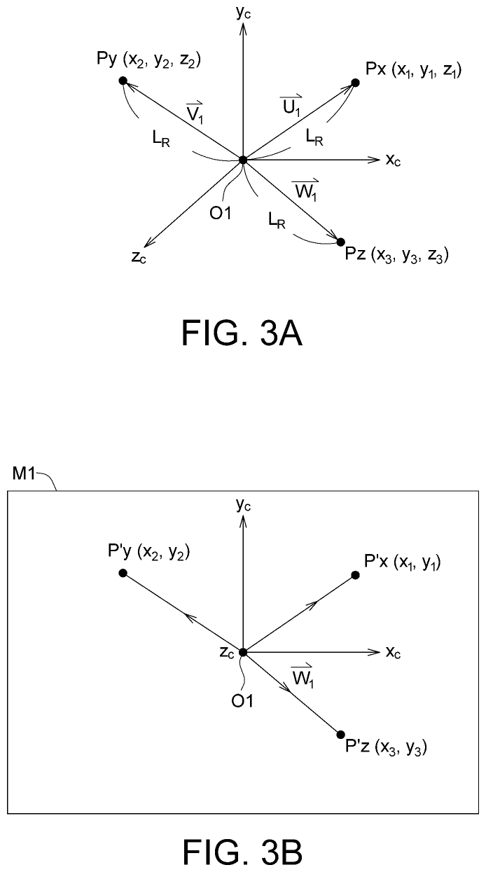

For example, referring to FIGS. 3A and 3B, FIG. 3A shows a schematic diagram of the robotic arm 110 in FIG. 1 moving relative to the reference point O1 in space, and FIG. 3B shows a schematic diagram of the image M1, captured by the camera 120, of the projection points Px, Py, and Pz moving on the test plane 20. During the calibration process, the camera 120 could continuously capture the image M1 of the projection points Px, Py, and Pz moving on the test plane 20, so that the controller 140 could analyze trajectory changes of the projection points Px, Py, and Pz on the test plane 20 in real time. In FIG. 3A, x_{C}-y_{C}-z_{C} is the camera reference coordinate system, and the space vectors \vec{U₁}, \vec{V₁}, \vec{W₁} are the vectors that the projection points start from the reference point O1 (origin) of the camera reference coordinate system (x_{C}-y_{C}-z_{C}) and respectively move by length L_{R} along the axes x_{R}, y_{R} and z_{R} of the robotic arm reference coordinate system (x_{R}-y_{R}-z_{R}). In an embodiment, the moving length L_{R} along each axis x_{R}, y_{R} and z_{R} of the robotic arm reference coordinate system (x_{R}-y_{R}-z_{R}) could be equal or unequal. In FIG. 3B, the image M1 is a plane image, and the axis z_{C} is perpendicular to the image M1. Although FIG. 3B shows the camera's reference coordinate system (x_{C}-y_{C}-z_{C}) and vector arrows, the actual image M1 may not have the coordinate image and the arrow image. The projection points Px(x₁,y₁,z₁), Py(x₂,y₂,z₂) and Pz(x₃,y₃,z₃) in the space of FIG. 3A are, for example, vector end points, which correspond to P′x(x₁,y₁), P′y(x₂,y₂) and P′z(x₃,y₃) of the image M1 of FIG. 3B. Px(x₁,y₁,z₁), Py(x₂,y₂,z₂) and Pz(x₃, y₃, z₃) in space are projected on the test plane 20 to form P′x(x₁,y₁), P′y(x₂,y₂) and P′z(x₃,y₃) respectively.

In step S111, as shown in FIGS. 1 and 3A, the controller 140 controls the robotic arm 110 to move so that the projection point Px of the first light L1 emitted by the tool 10 moves by a first space vector \vec{U₁}(x₁,y₁,z₁) from the reference point O1 along a first space vector (for example, the x_{R} axis) of the robotic arm reference coordinate system (x_{R}-y_{R}-z_{R}). In addition, the value (or length) of the first space vector \vec{U₁}(x₁,y₁,z₁) is L_{R}, and an end point of the first space vector \vec{U₁}(x₁,y₁,z₁) is the projection point Px(x₁,y₁,z₁) in FIG. 3A. In addition, the reference point O1 may be any point on the test plane 20, for example, the center point of the test plane 20.

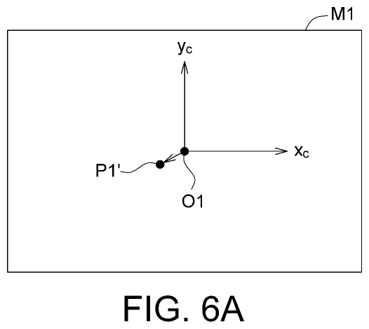

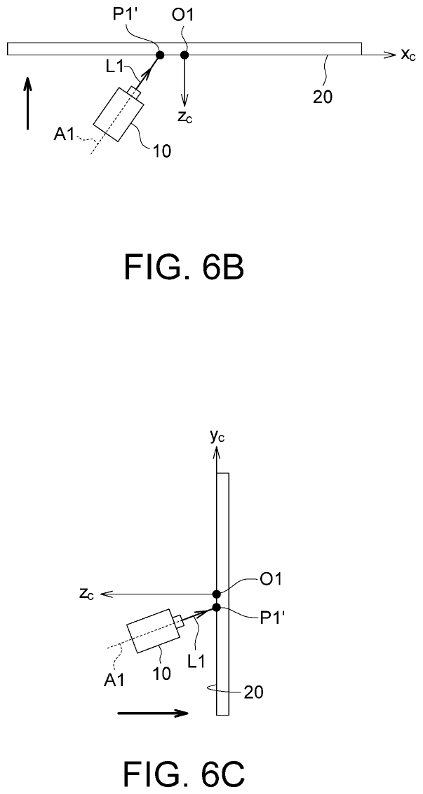

In step S111, the controller 140 could analyze the image M1 captured by the camera 120, and, as shown in FIG. 3B, determine whether the projection point P1′ (shown in FIG. 6A, and position of the projection point P1′ changes with moving of the tool 10) in the image M1 corresponds to (or is located/coincident with) the reference point O1 in the image M1. When the projection point P1′ does not correspond to the reference point O1 in the image M1, the robotic arm 110 is controlled to move until the projection point P1′ corresponds to the reference point O1 in the image M1. When the projection point P1′ corresponds to the reference point O1 in the image M1, the controller 140 controls the robotic arm 110 to move so that the projection point P1′ moves by the first space vector \vec{U₁}(x₁,y₁,z₁) from the reference point O1 along the first space vector (for example, the axis x_{R}) of the robotic arm reference coordinate system (x_{R}-y_{R}-z_{R}). During the moving, the controller 140 analyzes the image M1 captured by the camera 120 and determines whether the projection point in the image M1 has moved by the first space vector \vec{U₁}(x₁,y₁,z₁).

In step S112, the controller 140 could analyze the image M1 captured by the camera 120. As shown in FIG. 3B, the image M1 is a planar image, and thus the point Px(x₁, y₁, z₁) becomes P′x(x₁, y₁) to obtain the value of the first plane coordinate P′x(x₁,y₁) of the projection point P′x of the first space vector \vec{U₁}(x₁,y₁,z₁), that is, the first axis coordinate value x₁ and the second axis coordinate value y₁.

In step S113, the controller 140 controls the tool 10 moves by a second space vector \vec{V₁}(x₂,y₂,z₂) from the reference point O1 along a second space vector (for example, the y_{R} axis) of the robotic arm reference coordinate system (x_{R}-y_{R}-z_{R}). The value (or length) of the second space vector \vec{V₁}(x₂,y₂,z₂) is L_{R}, and an end point of the second space vector \vec{V₁}(x₂,y₂,z₂) is the projection point Py(x₂, y₂, z₂) in FIG. 3A.

Similarly, in step S113, the controller 140 could analyze the image M1 captured by the camera 120 and determine whether the projection point P1′ in the image M1 corresponds to (or is located/coincident with) the reference point O1 in the image M1. When the projection point P1′ does not correspond to the reference point O1 in the image M1, the robotic arm 110 is controlled to move until the projection point P1′ corresponds to the reference point O1 in the image M1. When the projection point P1′ corresponds to the reference point O1 in the image M1, the controller 140 controls the robotic arm 110 to move so that the projection point P1′ moves by the second space vector \vec{V₁}(x₂,y₂,z₂) from the reference point O1 along the second space vector (for example, the y_{R} axis) of the robotic arm reference coordinate system (x_{R}-y_{R}-z_{R}). During the moving, the controller 140 analyzes the image M1 captured by the camera 120 and determines whether the projection point P1′ in the image M1 has moved by the second space vector \vec{V₁}(x₂, y₂, z₂).

In step S114, the controller 140 could analyze the image captured by the camera 120 to obtain the value of the first plane coordinate P′y(x₂, y₂) of the projection point P′y of the second space vector \vec{V₁}(x₂, y₂, z₂), that is, the first axis coordinate value x₂ and the second axis coordinate value y₂.

In step S115, the controller 140 controls the tool 10 moves by a third space vector \vec{W₁}(x₃,y₃,z₃) from the reference point O1 along a third space vector (for example, the z_{R} axis) of the robotic arm reference coordinate system (x_{R}-y_{R}-z_{R}). The value (or length) of the third space vector \vec{W₁}(x₃,y₃,z₃) is L_{R}, and an end point of the third space vector \vec{W₁}(x₃, y₃, z₃) is the projection point Pz(x₃, y₃, z₃) in FIG. 3A.

Similarly, in step S115, the controller 140 could analyze the image M1 captured by the camera 120 and determine whether the projection point P1′ in the image M1 corresponds to (or is located/coincident with) the reference point O1 in the image M1. When the projection point P1′ does not correspond to the reference point O1 in the image M1, the robotic arm 110 is controlled to move until the projection point P1′ corresponds to the reference point O1 in the image M1. When the projection point P1′ corresponds to the reference point O1 in the image M1, the controller 140 controls the robotic arm 110 to move so that the projection point P1′ moves by the third space vector \vec{W₁}(x₃,y₃,z₃) from the reference point O1 along the third space vector (for example, the z_{R} axis) of the robotic arm reference coordinate system (x_{R}-y_{R}-z_{R}). During the moving, the controller 140 analyzes the image M1 captured by the camera 120 and determines whether the projection point P1′ in the image M1 has moved by the third space vector \vec{W₁}(x₃,y₃,z₃).

In step S116, the controller 140 could analyze the image captured by the camera 120 to obtain the value of the first plane coordinate P′z(x₃, y₃) of the projection point P′z of the third space vector \vec{W₁}(x₃,y₃,z₃), that is, the first axis coordinate value x₃ and the second axis coordinate value y₃.

In step S117, the controller 140 establishes the first conversion relationship T1 between the camera reference coordinate system (x_{C}-y_{C}-z_{C}) and the robotic arm reference coordinate system (x_{R}-y_{R}-z_{R}) according to mutually orthogonal characteristics of the first space vector \vec{U₁}(x₁,y₁,z₁), the second space vector \vec{V₁}(x₂,y₂,z₂) and the third space vector \vec{W₁}(x₃,y₃,z₃). For example, the controller 140 could use the following equations (1) to (3) to obtain the third axis coordinate values z₁, z₂ and z₃. As a result, the controller 140 obtains x₁, x₂, x₃, y₁, y₂, y₃, z₁, z₂ and z₃. Then, the controller 140 establishes the first conversion relationship T1 according to the following formula (4).

As shown in formula (5), the controller 140 could use the first conversion relationship T1 to convert the projection point movement vector S_{W} into the robotic arm movement vector S_{R}, wherein the projection point movement vector S_{W} is the movement vector of the projection point P1 on the test plane 20 relative to the camera reference coordinate system (x_{C}-y_{C}-z_{C}), and the projection point movement vector S_{W} is the movement vector of the robotic arm 110 relative to the robotic arm reference coordinate system (x_{R}-y_{R}-z_{R}). The robotic arm reference coordinate system (x_{R}-y_{R}-z_{R}) could be established at any position of the robotic arm 110, for example, the base 111 of the robotic arm 110. Equations (1), (2), and (3) represent the space vectors \vec{U₁}, \vec{V₁} and \vec{W₁} orthogonal to each other. The first conversion relation T1 in formula (4) is the inverse matrix of the space vectors \vec{U₁}, \vec{V₁} and \vec{W₁} divided by the length of the vector (the result is unit vector). Formula (5) represents that the dot product of the first conversion relationship T1 and the projection point movement vector S_{W} is equal to the robotic arm movement vector S_{R}.

$$\begin{matrix}\vec{{U}_{1}} \cdot \vec{{V}_{1}} = 0 & ( 1 ) \\ \vec{{V}_{1}} \cdot \vec{{W}_{1}} = 0 & ( 2 ) \\ \vec{{U}_{1}} \cdot \vec{{W}_{1}} = 0 & ( 3 ) \\ {T}_{1} = {[ \begin{matrix}\frac{\vec{{U}_{1}}}{‖ \vec{{U}_{1}} ‖} & \frac{\vec{{V}_{1}}}{‖ \vec{{V}_{1}} ‖} & \frac{\vec{{W}_{1}}}{‖ \vec{{W}_{1}} ‖}\end{matrix} ]}^{- 1} & ( 4 ) \\ {S}_{R} = {T}_{1} \cdot {S}_{w} = {[ \begin{matrix}\frac{\vec{{U}_{1}}}{‖ \vec{{U}_{1}} ‖} & \frac{\vec{{V}_{1}}}{‖ \vec{{V}_{1}} ‖} & \frac{\vec{{W}_{1}}}{‖ \vec{{W}_{1}} ‖}\end{matrix} ]}^{- 1} \cdot {S}_{w} & ( 5 )\end{matrix}$$

Then, in step S120, the robotic arm system 100 obtains the tool axis vector T_{ez} of the tool 10 relative to the installation surface reference coordinate system (x_{f}-y_{f}-z_{f}).

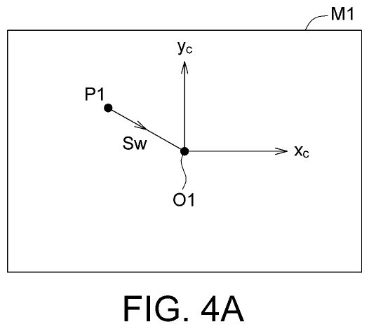

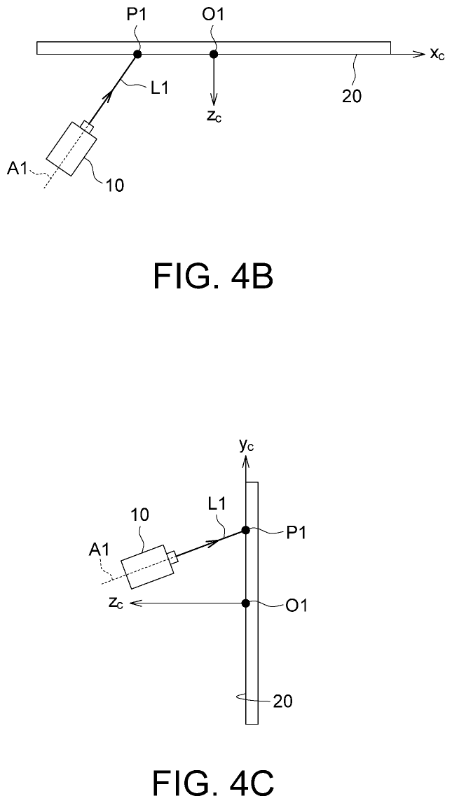

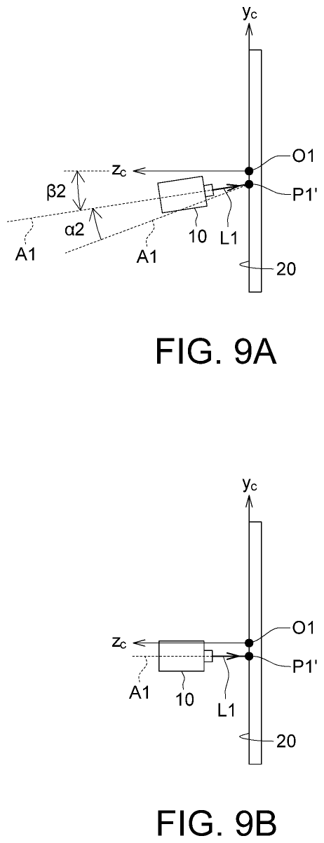

For example, referring to FIGS. 4A to 9B, which shows schematic diagrams of process of obtaining the tool axis vector T_{ez} according to an embodiment of the present disclosure. FIG. 4A shows a schematic diagram of the image M1 showing the projection point P1 captured by the camera 120 of FIG. 1 on the test plane 20, FIG. 4B shows a schematic diagram of the test plane 20 viewed from the axis −y_{C} of FIG. 1, and FIG. 4C is a schematic diagram of the test plane 20 viewed from the axis −x_{C} of FIG. 1. As shown in FIGS. 4B and 4C, the tool axis A1 of the tool 10 is inclined relative to the plane x_{C}-y_{C} of the camera reference coordinate system (x_{C}-y_{C}-z_{C}), that is, the tool axis A1 is not perpendicular to the plane x_{C}-y_{C} of the camera reference coordinate system (x_{C}-y_{C}-z_{C}). However, through the following process of obtaining the tool axis vector T_{ez}, the tool axis A1 of the tool 10 could be adjusted to the plane x_{C}-y_{C} perpendicular to the camera reference coordinate system (x_{C}-y_{C}-z_{C}), as shown in FIGS. 8 and 9B. Then, the controller 140 could obtain the tool axis vector T_{ez} according to such state (i.e., the tool axis A1 is perpendicular to the plane x_{C}-y_{C} of the camera reference coordinate system (x_{C}-y_{C}-z_{C})) of the joint angles of the joints J1 to J6 of the robotic arm 110. Further description is given below.

In step S121, as shown in FIGS. 4B and 4C, the projection point P1 of the first light L1 emitted by the tool 10 projected on the test plane 20 along the tool axis A1. Then, the camera 120 captures the image M1 of the test plane 20. As shown in FIG. 4A, the image M1 has image of the projection point P1. Then, the controller 140 obtains the projection point movement vector S_{W} of the projection point P1 projected on the test plane 20 by the tool 10 relative to the reference point O1 according to the captured image M1.

In step S122, the controller 140 obtains the robotic arm movement vector S_{R} according to the first conversion relationship T1 and the projection point movement vector S_{W}. For example, the controller 140 could substitute the projection point movement vector S_{W} into the above formula (5) to obtain (or calculate) the robotic arm movement vector S_{R} required for the robotic arm 110 to move the projection point P1 to approach or coincide with the reference point O1. The purpose of steps S122 and S123 is to prevent the projection point P1′ from being out of the test plane 20 after of the robotic arm moving or rotating.

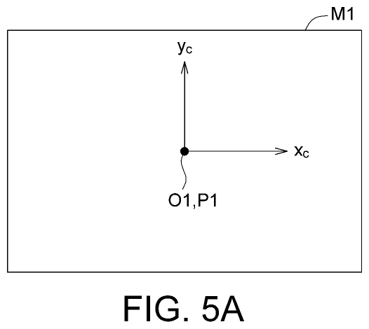

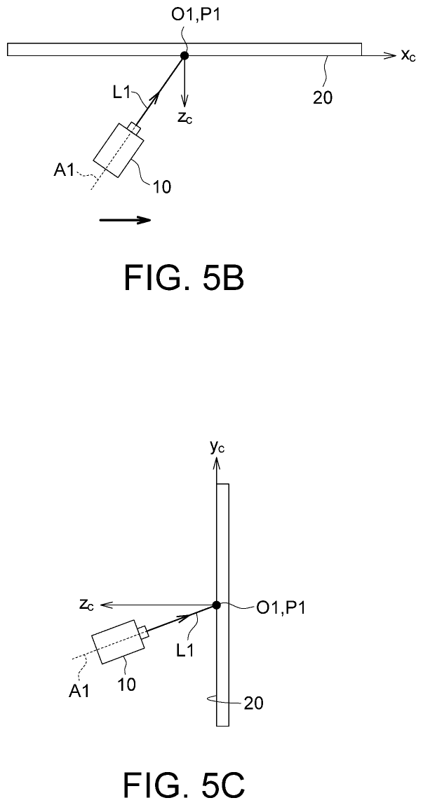

In step S123, as shown in FIGS. 5A to 5C, FIG. 5A shows a schematic diagram of an image in which the projection point P1 of FIG. 4A coincides with the reference point O1 of the test plane 20, and FIG. 5B shows a schematic diagram of the test plane 20 viewed from the axis −y_{C} of FIG. 1, and FIG. 5C shows a schematic view of the test plane 20 viewed from the axis −x_{C} of FIG. 1. In step S123, as shown in FIGS. 5B to 5C, the controller 140 controls the robotic arm 110 to move by the robotic arm movement vector S_{R} to make the projection point P1 of the tool 10 approach the reference point O1. For example, the projection point P1 is coincident reference point O1. However, in another embodiment, the projection point P1 could be moved to be close to but not coincide with the reference point O1. Then, the camera 120 captures the image M1 of the test plane 20, as shown in FIG. 5A, the image M1 has the image of the projection point P1.

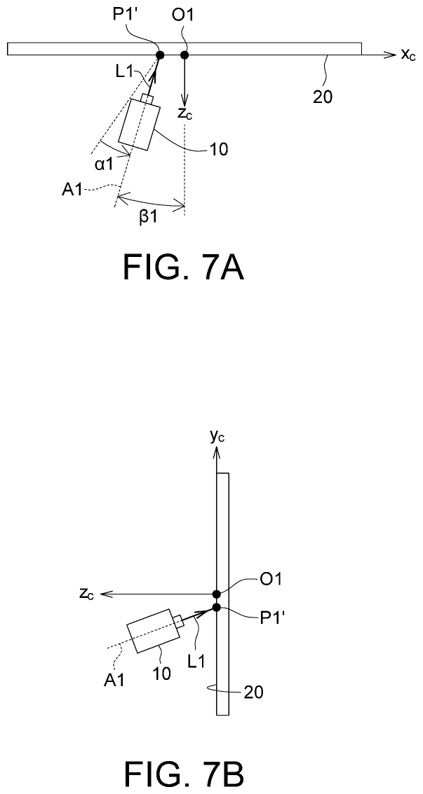

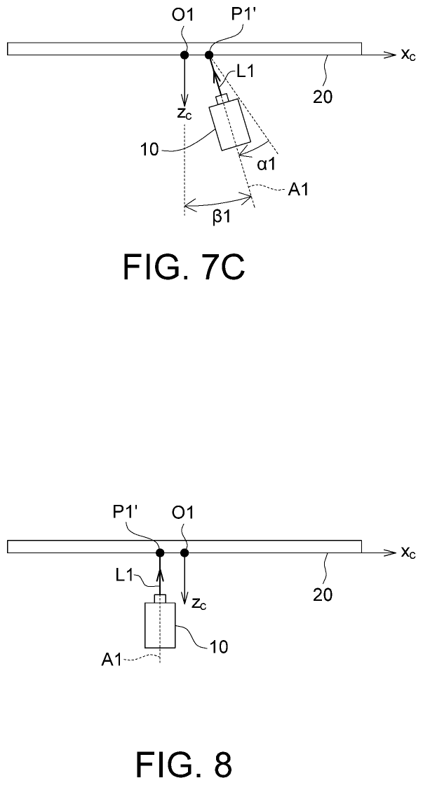

Due to the projection point P1 approaching to the reference point O1 in step S123, the moved projection point P1′ in the subsequent step S124A (the moved projection point P1′ is shown in FIG. 6A) will not fall out of the test plane 20, and/or the projection point P1′ after the tool 10 is rotated in the subsequent step S124B (the projection point P1′, after the tool 10 is rotated, is shown in FIG. 7A) will not fall outside the test plane 20. In another embodiment, if the moved projected point P1′ in step S124A does not fall out of the test plane 20 and the projected point P1′ after the tool 10 is rotated in step S124B does not fall out of the test plane 20, the steps S122 and S123 could be omitted.

Then, in step S124, the controller 140 could perform the offset correction to the tool axis A1 of the tool 10 relative to the first axis (for example, the axis x_{C}). Steps S124A to S124C are further described below.

In step S124A, as shown in FIGS. 6A to 6C, FIG. 6A shows a schematic diagram of the image where the projection point P1 of FIG. 5A deviates from the reference point O1 of the test plane 20, and FIG. 6B shows a schematic view of the test plane 20 viewed from the axis −y_{C} of FIG. 1, and FIG. 6C shows a schematic view of the test plane 20 viewed from the axis −x_{C} of FIG. 1. In step S124A, as shown in FIGS. 6B and 6C, the robotic arm 110 drives the tool 10 to move along the third axis (for example, the axis z_{C}) of the camera reference coordinate system (x_{C}-y_{C}-z_{C}), as shown by the arrow showing that the tool 10 moves or translates (for example, moves in a straight direction) toward the axis −z_{C}. Then, the camera 120 captures the image M1 of the test plane 20. As shown in FIG. 6A, the image M1 has image of the moved projection point P1′. Since the tool axis A1 is not perpendicular to the test plane 20, the position of the projection point P1 of FIG. 5A is changed to the position of the projection point P1′ of FIG. 6A after the tool 10 moves along the third axis (for example, the axis z_{C}) of the camera reference coordinate system (x_{C}-y_{C}-z_{C}).

In step S124B, the controller 140 determines whether the position of the projection point P1 on the test plane 20 in the first axis (for example, the axis x_{C}) changes according to the image captured by the camera 120. If so (for example, in a translation test of the first axis x_{C}, the position of the projection point P1 of FIG. 5B moves along the axis −x_{C} to the position of the projection point P1′ of FIG. 6B, and it represents deviation occurs in the first axis x_{C}, and thus subsequent adjustments are required), the process proceeds to S1240; if not (it represents no deviation occurs in the first axis x_{C}), the process proceeds to step S125A.

In step S124C, as shown in FIGS. 7A and 7B, which show schematic diagrams of the tool 10 in FIG. 6B rotating around the axis y_{C} of the camera reference coordinate system (x_{C}-y_{C}-z_{C}). The robotic arm 110 drives the tool 10 to rotate by an angle around the second axis (for example, the axis y_{C}) of the camera reference coordinate system (x_{C}-y_{C}-z_{C}) to reduce the angle β1 between the tool axis A1 and the axis z_{C}, namely, it makes the tool axis A1 move toward trend of being parallel to the axis z_{C}. In addition, the angle β1 is, for example, an arbitrary angle. The angle is determined by way of trial and error here. In detail, the tool axis A1 is counterclockwise rotated by an arc angle α1 with the axis y_{C} as the fulcrum or center, so as to gradually reduce the difference between the tool axis A1 and the axis z_{C}. After being rotated, the projection point P1 on the test plane 20 may not remain at the original position.

In detail, in step S124A, after the robotic arm 110 drives the tool 10 to move or translate along the axis +/−z_{C} of the camera reference coordinate system (x_{C}-y_{C}-z_{C}). As shown in FIG. 7A, if the projection point P1′ moves or shifts toward the negative first axis (for example, the axis −x_{C}), the robotic arm 110 drives the tool 10 to rotate around the positive second axis (for example, the axis +y_{C}) to reduce the angle β1 between the tool axis A1 and the axis z_{C}, that is, it makes the tool axis A1 (the projection on the plane x_{C}-z_{C} of the camera reference coordinate system (x_{C}-y_{C}-z_{C})) move toward trend of being parallel to the axis z_{C} (In other words, it makes the projection of the tool axis A1 projected on the plane x_{C}-y_{C} of the camera reference coordinate system (x_{C}-y_{C}-z_{C}) move toward trend of being perpendicular to the test plane 20). In addition, as long as the projection of the tool axis A1 projected on the plane x_{C}-y_{C} of the camera reference coordinate system (x_{C}-y_{C}-z_{C}) toward trend of being parallel to the axis z_{C}, the embodiment of the disclosure does not limit whether the position of the projection point P1′ has changed during rotation.

In another embodiment, as shown in FIG. 7C, FIG. 7C shows a schematic diagram of the projection point P1′ of FIG. 6B is offset toward the positive first axis (for example, the axis +x_{C}) in another embodiment. In step S124A, after the robotic arm 110 drives the tool 10 to move along the axis +/−z_{C} of the camera reference coordinate system (x_{C}-y_{C}-z_{C}), if the projection point P1′ moves toward the positive first axis (for example, axis +x_{C}) moves or shifts, the robotic arm 110 drives the tool 10 to rotate around the negative second axis (for example, the axis −y_{C}) to reduce the angle β1 between the tool axis A1 and the axis z_{C}. The tool axis A1 is clockwise rotated by the arc angle α1 with the projection point P1′ as the fulcrum, so as to gradually reduce the angle β1 between the tool axis A1 and the axis z_{C}, that is, it makes the tool axis A1 (the projection on the plane x_{C}-z_{C} of the camera reference coordinate system (x_{C}-y_{C}-z_{C})) move toward trend of being parallel to the axis z_{C} (in other words, it makes the projection of the tool axis A1 projected on the plane x_{C}-y_{C} of the camera reference coordinate system (x_{C}-y_{C}-z_{C}) move toward trend of being perpendicular to the test plane 20).

The controller 140 repeats steps S124A to S124C until the tool axis A1 of the tool 10 projected on the plane x_{C}-y_{C} of the camera reference coordinate system (x_{C}-y_{C}-z_{C}) (for example, the angle of viewed in FIG. 8) is parallel to the axis z_{C} of the camera reference coordinate system (x_{C}-y_{C}-z_{C}), or the projection of the tool axis A1 projected on the plane x_{C}-y_{C} of the camera reference coordinate system (x_{C}-y_{C}-z_{C}) is perpendicular to the test plane 20, as shown in FIG. 8. So far, the offset correction for the tool axis A1 of the tool 10 relative to the axis x_{C} is completed. Furthermore, when the robotic arm 110 drives the tool 10 to move along the axis +/−z_{C} of the camera reference coordinate system (x_{C}-y_{C}-z_{C}), if a position change amount of the projection of the projection point P1′ projected on the plane x_{C}-y_{C} of the camera reference coordinate system (x_{C}-y_{C}-z_{C}) along the axis x_{C} is substantially equal to 0 (that is, the position of the projection of the projection point P1′ projected on the plane x_{C}-y_{C} of the camera reference coordinate system (x_{C}-y_{C}-z_{C}) along the axis x_{C} will not change any more), which means that the projection of the tool axis A1 projected on the plane x_{C}-y_{C} of the camera reference coordinate system (x_{C}-y_{C}-z_{C}) has been parallel to the axis z_{C} of the plane x_{C}-y_{C} of the camera reference coordinate system (x_{C}-y_{C}-z_{C}), the process could proceed to step S125, and the controller 140 executes the offset correction for the tool axis A1 of the tool 10 relative to the second axis (for example, the axis y_{C}), as shown in process of steps S125A to S125C.

In steps S125A to S125C, the controller 140 and the robotic arm 110 could use the process similar to steps S124A to S124C to complete the offset correction to the axis y_{C}. Hereinafter, further examples are shown in FIGS. 6A and 6C and FIGS. 9A to 9B.

In step S125A, as shown in FIG. 6C, the robotic arm 110 drives the tool 10 to move along the third axis (for example, the axis z_{C}) of the camera reference coordinate system (x_{C}-y_{C}-z_{C}), as shown in the arrow showing that the tool 10 moves or translates toward the axis −z_{C}. Then, the camera 120 captures the image M1 of the test plane 20, as shown in FIG. 6A, the image M1 has the image of the moved projection point P1′. Due to the tool axis A1 being not perpendicular to the test plane 20, after the tool 10 moves along the third axis (for example, the axis z_{C}) of the camera reference coordinate system (x_{C}-y_{C}-z_{C}), the position of the projection point P1 of FIG. 5A is changed to the position of the projection point P1′ of FIG. 6A. In another embodiment, if step S124A has been performed, step S125A could be optionally omitted.

In step S125B, the controller 140 determines whether the position of the projection point P1 on the test plane 20 in the second axis (for example, the axis y_{C}) changes according to the image M1 captured by the camera 120. If so (for example, the position of the projection point P1 of FIG. 5C moves to the position of the projection point P1′ of FIG. 6C along the axis −y_{C}), the process proceeds to S1250; if not, the process proceeds to S126.

In step S125C, as shown in FIG. 9A, FIG. 9A shows a schematic diagram of the tool 10 of FIG. 6C rotating around the axis x_{C} of the camera reference coordinate system (x_{C}-y_{C}-z_{C}). The robotic arm 110 drives the tool 10 to rotate by an angle α2 around the first axis (for example, the axis −x_{C}) of the camera reference coordinate system (x_{C}-y_{C}-z_{C}) to reduce the angle β2 between the tool axis A1 and the axis z_{C}, that is, it makes the tool axis A1 move toward trend of being parallel to the axis z_{C}. In addition, the angle α2 is, for example, an arbitrary angle.

In detail, in step S125A, after the robotic arm 110 drives the tool 10 to move or translate along the axis +/−z_{C} of the camera reference coordinate system (x_{C}-y_{C}-z_{C}). As shown in FIG. 9A, if the projection point Pt moves or shifts toward the negative second axis (for example, the axis −y_{C}), the robotic arm 110 drives the tool 10 to rotate around the negative first axis (for example, the axis −x_{C}) to reduce the angle β2 between the tool axis A1 and the axis z_{C}, that is, the tool axis A1 is clockwise rotated by the arc angle α2 with the projection point Pt as the fulcrum, so as to gradually reduce the angle β2 between the tool axis A1 and the axis z_{C}, that is, it makes the tool axis A1 (the projection on the plane x_{C}-z_{C} of the camera reference coordinate system (x_{C}-y_{C}-z_{C})) move toward trend of being parallel to the axis z_{C} (in other words, it makes the projection of the tool axis A1 projected on the plane x_{C}-y_{C} of the camera reference coordinate system (x_{C}-y_{C}-z_{C}) move toward trend of being perpendicular to the test plane 20). In addition, as long as the projection of the tool axis A1 projected on the plane x_{C}-y_{C} of the camera reference coordinate system (x_{C}-y_{C}-z_{C}) toward trend of being parallel to the axis z_{C}, the embodiment of the disclosure does not limit whether the position of the projection point Pt has changed during rotation.

The controller 140 repeats steps S125A to S125C until the tool axis A1 of the tool 10 projected on the plane y_{C}-z_{C} of the camera reference coordinate system (x_{C}-y_{C}-z_{C}) (for example, the angle of viewed in FIG. 9B) is parallel to the axis z_{C} of the camera reference coordinate system (x_{C}-y_{C}-z_{C}), or the projection of the tool axis A1 projected on the plane x_{C}-y_{C} of the camera reference coordinate system (x_{C}-y_{C}-z_{C}) is perpendicular to the test plane 20, as shown in FIG. 9B. So far, the offset correction to the tool axis A1 of the tool 10 relative to the axis y_{C} is completed. Furthermore, when the robotic arm 110 drives the tool 10 to move along the axis +/−z_{C} of the camera reference coordinate system (x_{C}-y_{C}-z_{C}), if a position change amount of the projection of the projection point P1′ projected on the plane x_{C}-y_{C} of the camera reference coordinate system (x_{C}-y_{C}-z_{C}) along the axis y_{C} is substantially equal to 0 (that is, the position of the projection of the projection point P1′ projected on the plane x_{C}-y_{C} of the camera reference coordinate system (x_{C}-y_{C}-z_{C}) along the axis y_{C} will not change any more), which means that the projection of the tool axis A1 projected on the plane x_{C}-y_{C} of the camera reference coordinate system (x_{C}-y_{C}-z_{C}) has been parallel to the axis z_{C} of the plane x_{C}-y_{C} of the camera reference coordinate system (x_{C}-y_{C}-z_{C}), the process could proceed to step S126.

In step S126, after the offset correction to the first axis and the second axis is completed (it means that the tool axis A1 is perpendicular to the test plane 20, the purpose of steps S124 and S125 is to correct the shift along the axis x_{C} and the axis y_{C} axis), the controller 140 establishes a second conversion relationship T₂ according to the posture of the robotic arm 110 when the tool axis A1 is perpendicular to the test plane 20, and obtains the tool axis vector T_{ez} according to the second conversion relationship T₂, wherein the tool axis vector T_{ez} is, for example, parallel to or coincides with the tool axis A1. For example, the controller 140 establishes the second conversion relationship T₂ according to the joint angles of the joints J1 to J6 of the robotic arm 110 when the tool axis A1 is perpendicular to the test plane 20. The second conversion relationship T₂ is the conversion relationship of the installation surface (or flange surface) reference coordinate system (x_{f}-y_{f}-z_{f}) of an installation surface 110s of the tool 10 relative to the robotic arm reference coordinate system (x_{R}-y_{R}-z_{R}). The tool 10 could be installed on the installation surface 110s, and the tool axis A1 of the tool 10 is not limited to be perpendicular to the installation surface 110s. In an embodiment, the second conversion relationship T₂ could be expressed in the following formula (6), and the elements in formula (6) could be obtained by the linkage parameters (Denavit-Hartenberg Parameters) of the robotic arm 110, the coordinates of the joints J1 to J6 and the tool center point WO1 relative to the installation surface reference coordinate system (x_{f}-y_{f}-z_{f}), wherein the link parameters could include link offset, joint angle, link length and Link twist. In addition, the second conversion relationship T₂ could be established by using a known kinematics method.

$${T}_{2} = [ \begin{matrix}{e}_{111} & {e}_{121} & {e}_{131} & {e}_{141} \\ {e}_{211} & {e}_{221} & {e}_{231} & {e}_{241} \\ {e}_{311} & {e}_{321} & {e}_{331} & {e}_{341} \\ 0 & 0 & 0 & 1\end{matrix} ] \qquad ( 6 )$$

As shown in the following formula (7), the vector z_{w} is the normal vector (i.e., the axis z_{C}) of the test plane 20 relative to the robotic arm reference coordinate system (x_{R}-y_{R}-z_{R}), and the vector T_{ez} is the vector (herein referred to as the “tool axis vector”) of the tool axis A1 relative to the installation surface reference coordinate system (x_{f}-y_{f}-z_{f}). The controller 140 could convert the vector z_{w} into the tool axis vector T_{ez} through the inverse matrix of the second conversion relationship T₂.

T_{ez}=T2⁻¹·z_{w} (7)

In step S130, the robotic arm system 100 executes the step of obtaining calibration point information groups. Further examples are given below.

In step S131, referring to FIGS. 10A to 10B, FIG. 10A shows a schematic diagram of the second light L2 emitted by the light source 130 of FIG. 1 and the first light L1 emitted by the tool 10 along the tool axis A1 that intersect at the tool center point WO1, and FIG. 10B shows a schematic diagram of the projection point P_{L2} of the second light L2 emitted by the light source 130 of FIG. 10A projected on the test plane 20 and the projection point P_{L1} of the first light L1 emitted by the tool 10 along the tool axis A1 projected on the test plane 20 being two separated points respectively. In this step, the angle of the light source 130 could be adjusted to make the second light L2 emitted by the light source 130 and the first light L1 emitted by the tool 10 intersect at the tool center point WO1, as shown in FIG. 10A.

In the present embodiment, the tool 10 is shown by taking the luminance meter as an example, and the tool center point WO1 is the virtual tool center point. The tool center point WO1 is, for example, the focus of the first light L1 (detection light) projected by the tool 10. In another embodiment, the tool 10 is, for example, a machining tool, and the tool center point WO1 is the tool center point, such as a solid tool tip point. In summary, the tool center point of the embodiment of the present disclosure could be the physical tool center point or the virtual tool center point.

In one of the methods for adjusting the angle of the light source 130, the controller 140 could obtain the angle θ between the second light L2 emitted by the light source 130 and the first light L1 emitted by the tool 10 along the direction (dotted line from the rotation fulcrum 131 of the tool axis A1) perpendicular to the tool axis A1 according to the following formula (8), and then the angle of the light source 130 could be adjusted to the angle θ by manual or a mechanism (not shown) controlled by the controller 140, so that the emitted second light L2 emitted by the light source 130 and the first light L1 emitted by the tool 10 intersect at the tool center point WO1. The aforementioned mechanisms are, for example, various mechanisms that could drive the light source 130 to rotate, such as a linkage mechanism, a gear set mechanism, etc. Due to the angle θ being given (known), the angle of the light source 130 could be quickly adjusted so that the second light L2 emitted and the first light L1 emitted by the tool 10 intersect at the tool center point WO1. When the angle of the light source 130 is adjusted to the angle θ, the relative relationship between the light source 130 and the tool 10 could be fixed to fix the relative relationship between the tool center point WO1 and the tool 10.

$$θ = {tan}^{- 1} \frac{( H 1 + H 2 )}{H 3} \qquad ( 8 )$$

In formula (8), H1 is the distance (for example, the focal length of the first light L1) between the tool center point WO1 and a light emitting surface 10s of the tool 10 along the tool axis A1, and H2 is the distance between the light emitting surface 10s of the tool 10 and the rotation fulcrum 131 of the light source 130 along the tool axis A1, and H3 is the vertical distance (perpendicular to the tool axis A1) between the rotation fulcrum 131 of the light source 130 and the tool axis A1.

As shown in FIG. 10B, since the tool center point WO1 has not yet coincided with the test plane 20, the projection point P_{L2} of the second light L2 emitted by the light source 130 projected on the test plane 20 and the projection point P_{L1} of the first light L1 emitted on the tool 10 projected on the test plane 20 are two separated points.

In step S132, the controller 140 executes the step of obtaining the calibration point information group. For example, the controller 140 could control the robotic arm 110 to make a plurality of calibration points whose tool center point WO1 coincide with the reference point O1 of the test plane 20 under a plurality of different postures, and accordingly record the calibration point information group of each calibration point. For example, the controller 140 could control the robotic arm 110 in a posture to make the tool center point WO1 coincide with the reference point O1 of the test plane 20, and accordingly record the calibration point information group in such posture. Then, the controller 140 controls the robotic arm 110 in another posture to make the tool center point WO1 coincide with the reference point O1 of the test plane 20, and accordingly record the calibration point information group in such posture. According to this principle, the controller 140 could obtain several calibration point information groups of the robotic arm 110 in several different postures. Each calibration point information group could include the coordinates of the joints J1 to J6, and the coordinates of each joint could be the rotation angle of each joint relative to its preset starting point. At least one of the rotation angles of the robotic arm 110 in different postures could be different.

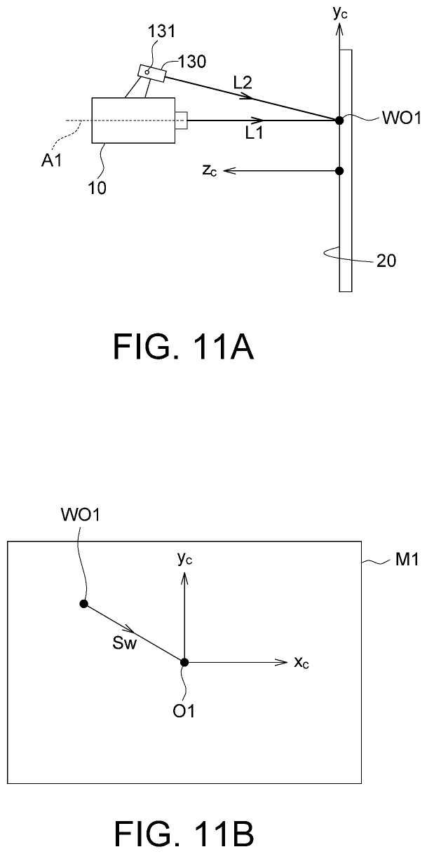

For example, referring to FIGS. 11A to 11B, FIG. 11A shows a schematic diagram of the tool center point WO1 of FIG. 10A overlapping the test plane 20, and FIG. 11B shows a schematic diagram of the tool center point WO1 of FIG. 11A is spaced from the reference point O1 by projection point movement vector S_{W}. In steps S132A to S132B, the controller 140 could control the robotic arm 110 to drive the tool 10 to move along the tool axis A1 until the tool center point WO1 coincides with the test plane 20, as shown in FIG. 11A.

In step S132A, as shown in FIG. 11A, the robotic arm 110 drives the tool 10 to move along the tool axis vector T_{ez}. In an embodiment, the robotic arm 110 could drive the tool 10 to move in the positive or negative direction of the tool axis A1. At this time, the tool axis vector T_{ez} is, for example, parallel to or coincides with the tool axis A1.

In step S132B, as shown in FIG. 11B, the controller 140 determines whether the tool center point WO1 coincides with the test plane 20 according to (e.g., analyzes) the image M1 of the test plane 20 captured by the camera 120. If yes, the process proceeds to step S1320; if not, the controller 140 repeats steps S132A to S132B until the tool center point WO1 coincides with the test plane 20, as shown in FIG. 11B. Furthermore, when the tool center point WO1 coincides with the test plane 20, a light spot (i.e., the tool center point WO1) will appear on the test plane 20. The controller 140 could analyze the image M1 of the test plane 20 captured by the camera 120 to determine whether the light spot has appeared on the test plane 20; if so, it means that the tool center point WO1 has coincided with the test plane 20 (for example, as shown in FIG. 11A), the process proceeds to step S1320; if no (for example, there are two light spots, namely the projection point P_{L1} and the projection point P_{L2}), it means that the tool center point WO1 has not coincided with the test plane 20, and then the process returns to step S132A, the robotic arm 110 continues to drive the tool 10 to move in the positive or negative direction of the tool axis A1 until the tool center point WO1 coincides with the test plane 20.

In step S132C, as shown in FIG. 11B, the controller 140 obtains the projection point movement vector S_{W} according to the image of the test plane 20 captured by the camera 120.

In step S132D, the controller 140 obtains the robotic arm movement vector S_{R} according to the first conversion relationship T1 and the projection point movement vector S_{W}. For example, the controller 140 could substitute the projection point movement vector S_{W} of FIG. 11B into the above formula (5) to calculate (or obtain) the required robotic arm movement vector S_{R} for the robotic arm 110 to move the tool center point WO1 to coincide with the reference point O1.

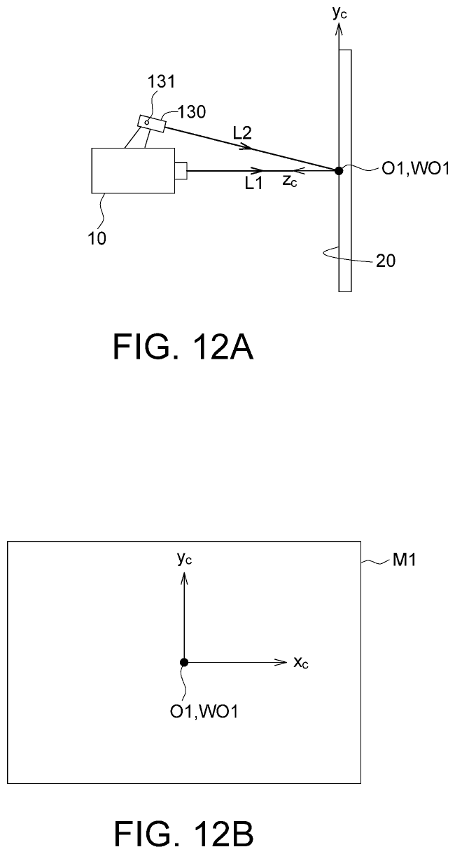

In step S132E, referring to FIGS. 12A to 12B, FIGS. 12A to 12B show schematic diagrams of the tool center point WO1 of FIG. 11A overlapping the reference point O1. In step S132E, the controller 140 controls the robotic arm 110 to move by the robotic arm movement vector S_{R} to make the tool center point WO1 coincide with the reference point O1.

In step S132F, the controller 140 determines whether the tool center point WO1 coincides with the reference point O1 of the test plane 20 according to (or analyzes) the image (for example, the image M1 shown in FIG. 12B) of the test plane 20 captured by the camera 120. If yes, the process proceeds to step S132G; if not, the process returns to step S132A.

Furthermore, if the tool axis A1 in FIG. 10A is not parallel to the axis z_{C}, after step S132E, the control command may be inconsistent with the actual movement of the robotic arm due to the movement error of the robotic arm, and it cause the situation of the projection point P_{L2} of the second light L2 emitted by the light source 130 projected on the test plane 20 and the projection point P_{L1} of the first light L1 emitted on the tool 10 projected on the test plane 20 are again two separated points, as shown in FIG. 10B. Such situation means that the tool center point WO1 is separated from the test plane 20 (meaning that the tool center point WO1 and the reference point O1 of the test plane 20 also not coincident). Therefore, the process could proceed to step S132A to make the tool center point WO1 coincide with the test plane 20. When the tool center point WO1 in step S132F coincides with the reference point O1 of the test plane 20, it means that the tool center point WO1 coincides with the test plane 20 and the tool center point WO1 also coincides with the reference point O1, and then the process proceeds to step S132G, if not, the process returns to step S132A.

In step S132G, the controller 140 records the joint angles of the joints J1 to J6 of the robotic arm 110 in the state where the tool center point WO1 coincides with the reference point O1 of the test plane 20, and uses it as one calibration point information group.

In step S132H, the controller 140 determines whether the number of the calibration point information groups has reached a predetermined number, for example, at least 3 groups, but could be more. When the number of the calibration point information groups has reached the predetermined number, the process proceeds to step S133, when the number of the calibration point information groups has not reached the predetermined number, the process proceeds to step S132I.

In step S132I, the controller 140 controls the robotic arm 110 to change the posture of the tool 10. For example, the controller 140 controls the robotic arm 110 to change the angle of at least one of the tool axis A1 of the tool 10 relative to the axis x_{C}, the axis y_{C} and the axis z_{C}, wherein the changed angle is, for example, 30 degrees, 60 degrees or other arbitrary. For example, the controller 140 could generate an Euler angle increments ΔRₓ, ΔR_{y}, ΔR_{z}, through a random number generator, to correct the azimuth angle (Euler angle) of the robotic arm 110, thereby changing the posture of the robotic arm 110. As this time, the azimuth angle of the robotic arm 110 could be expressed as (Rₓ+ΔRₓ, R_{y}+ΔR_{y}, R_{z}+ΔR_{z}), wherein (Rₓ, R_{y}, R_{z}) is the original azimuth angle of the robotic arm 110, Rₓ represents the Yaw angle, R_{y} represents Pitch angle, and R_{z} represents Roll angle. If the corrected azimuth angle exceeds the motion range of the robotic arm 110, the controller 140 could regenerate the Euler angle increments through the random number generator.

Then, the process returns to step S132A to record the calibration point information group of the robotic arm 110 in the new (different) posture of the tool 10. Furthermore, after the controller 140 controls the robotic arm 110 to change the posture of the tool 10, the tool center point WO1 of the tool 10 may deviate from the test plane 20. Therefore, the process returns to step S132A to make the tool center point WO1 coincide with the reference point O1 again, and in the state where the tool center point WO1 coincides with the reference point O1, another calibration point information group under different posture of the robotic arm 110 is recorded. Steps S132A to S132I are repeated until the number of the calibration point information groups recorded by the controller 140 reaches the predetermined number.

In step S133, when the number of the predetermined number groups recorded by the controller 140 reaches the predetermined number, the controller 140 obtains the tool center point coordinate TP of the tool center point WO1 relative to the installation surface reference coordinate system (x_{f}-y_{f}-z_{f}).

As shown in the following formula (9), the tool center point coordinate TP could be established according to a plurality of the calibration point information groups of the robotic arm 110 in a plurality of the different postures. The controller 140 could obtain (calculate) the coordinates of the tool center point WO1 according to the calibration point information groups, wherein the coordinates of each calibration point information group could be obtained through the linkage parameters (Denavit-Hartenberg Parameters) of the robot 110, the coordinates of the joints J1 to J6 and Information about the tool center point WO1 relative to the installation surface reference coordinate system (x_{f}-y_{f}-z_{f}), wherein the link parameters could include link offset, joint angle, link length and link twist.

The coordinates of the tool center point WO1 could be obtained (calculated) by the following formula (9):

$${T}_{2 i} [ \begin{matrix}{T}_{x} \\ {T}_{y} \\ {T}_{z} \\ 1\end{matrix} ] = [ \begin{matrix}{e}_{11 i} & {e}_{12 i} & {e}_{13 i} & {e}_{14 i} \\ {e}_{21 i} & {e}_{22 i} & {e}_{23 i} & {e}_{24 i} \\ {e}_{3 i} & {e}_{32 i} & {e}_{33 i} & {e}_{34 i} \\ 0 & 0 & 0 & 1\end{matrix} ] [ \begin{matrix}{T}_{x} \\ {T}_{y} \\ {T}_{z} \\ 1\end{matrix} ] = [ \begin{matrix}{P}_{x} \\ {P}_{y} \\ {P}_{z} \\ 1\end{matrix} ] \qquad ( 9 )$$

In formula (9), the matrix T₂ᵢ is 4×4 homogeneous conversion matrix which converts the coordinate system of the i^{th} calibration point information group to the installation surface reference coordinate system (x_{f}-y_{f}-z_{f}) from the robotic arm reference coordinate system (x_{R}-y_{R}-z_{R}). The matrix W_{1f} in formula (9) includes [Tₓ T_{y} T_{z}]^{t}, which is the coordinate W_{1f} (Tₓ, T_{y}, T_{z}) of the tool center point WO1 relative to the installation surface reference coordinate system (x_{f}-y_{f}-z_{f}), the matrix [Pₓ P_{y} P_{z} 1]^{t} includes the coordinate W_{1R} (Pₓ, P_{y}, P_{z}) of the tool center point WO1 relative to the robotic arm reference coordinate system (x_{R}-y_{R}-z_{R}) in space. Each calibration point information group could obtain three linear equations through formula (9). Therefore, n calibration point information groups could obtain 3n equations, and then the coordinates of the tool center point WO1 could be obtained through Pseudo-inverse matrix.

Furthermore, in formula (9), (e₁₁ᵢ, e₂₁ᵢ, e₃₁ᵢ) represents direction of the vector of the i^{th} calibration point information group in the first axis (for example, the axis x_{f}) relative to the robotic arm reference coordinate system (x_{R}-y_{R}-z_{R}). (e₁₂ᵢ, e₂₂ᵢ, e₃₂ᵢ) represents direction of the vector of the i^{th} calibration point information group in the second axis (for example, the axis y_{f}) relative to the robotic arm reference coordinate system (x_{R}-y_{R}-z_{R}). (e₁₃ᵢ, e₂₃ᵢ, e₃₃ᵢ) represents the direction of the vector of the i^{th} calibration point information group in the third axis (for example, the axis z_{f}) relative to the robotic arm reference coordinate system (x_{R}-y_{R}-z_{R}). The following formulas (10) and (11) could be obtained from formula (9).

$$\begin{matrix}[ \begin{matrix}{e}_{111} & {e}_{121} & {e}_{131} & - 1 & 0 & 0 \\ {e}_{211} & {e}_{221} & {e}_{231} & 0 & - 1 & 0 \\ {e}_{311} & {e}_{321} & {e}_{331} & 0 & 0 & - 1 \\ {e}_{112} & {e}_{122} & {e}_{132} & - 1 & 0 & 0 \\ {e}_{212} & {e}_{222} & {e}_{232} & 0 & - 1 & 0 \\ {e}_{312} & {e}_{322} & {e}_{332} & 0 & 0 & - 1 \\ {e}_{113} & {e}_{123} & {e}_{133} & - 1 & 0 & 0 \\ {e}_{213} & {e}_{223} & {e}_{233} & 0 & - 1 & 0 \\ {e}_{313} & {e}_{323} & {e}_{333} & 0 & 0 & - 1\end{matrix} ] [ \begin{matrix}{T}_{x} \\ {T}_{y} \\ {T}_{z} \\ {P}_{x} \\ {P}_{y} \\ {P}_{z}\end{matrix} ] = [ \begin{matrix}- {e}_{141} \\ - {e}_{241} \\ - {e}_{341} \\ - {e}_{142} \\ - {e}_{242} \\ - {e}_{342} \\ - {e}_{143} \\ - {e}_{243} \\ - {e}_{343}\end{matrix} ] & ( 10 ) \\ [ \begin{matrix}{T}_{x} \\ {T}_{y} \\ {T}_{z} \\ {P}_{x} \\ {P}_{y} \\ {P}_{z}\end{matrix} ] = {{T}_{3}^{t} ( {T}_{3} {T}_{3}^{t} )}^{- 1} [ \begin{matrix}- {e}_{141} \\ - {e}_{241} \\ - {e}_{341} \\ - {e}_{142} \\ - {e}_{242} \\ - {e}_{342} \\ - {e}_{143} \\ - {e}_{243} \\ - {e}_{343}\end{matrix} ] \\ {T}_{3} = [ \begin{matrix}{e}_{111} & {e}_{121} & {e}_{131} & - 1 & 0 & 0 \\ {e}_{211} & {e}_{221} & {e}_{231} & 0 & - 1 & 0 \\ {e}_{311} & {e}_{321} & {e}_{331} & 0 & 0 & - 1 \\ {e}_{112} & {e}_{122} & {e}_{132} & - 1 & 0 & 0 \\ {e}_{212} & {e}_{222} & {e}_{232} & 0 & - 1 & 0 \\ {e}_{312} & {e}_{322} & {e}_{332} & 0 & 0 & - 1 \\ {e}_{113} & {e}_{123} & {e}_{133} & - 1 & 0 & 0 \\ {e}_{213} & {e}_{223} & {e}_{233} & 0 & - 1 & 0 \\ {e}_{313} & {e}_{323} & {e}_{333} & 0 & 0 & - 1\end{matrix} ] & ( 11 )\end{matrix}$$

In formula (11), T₃^{t} is the transpose matrix of T₃, (T₃T₃^{t})⁻¹ is the inverse matrix of (T₃T₃^{t}), and the coordinate (Tₓ T_{y} T_{z}) is the tool center point coordinate TP, and the matrix T₃ is a calibration point information group matrix composed of the calibration point information groups.

If the number of the calibration point information groups is sufficient, substitute each element in the matrix T₂ᵢ corresponding to the i^{th} calibration point information group into formula (10) and relocate the matrix T₃ to obtain formula (11) to obtain the coordinate W_{1f} (Tx, Ty, Tz) of the tool center point WO1 relative to the installation surface reference coordinate system (x_{f}-y_{f}-z_{f}) and the coordinate W_{1R} (Pₓ, P_{y}, P_{z}) of the tool center point WO1 relative to the robotic arm reference coordinate system (x_{R}-y_{R}-z_{R}).

Of course, the above-mentioned tool center point calibration method is only an example, and each component and/or calibration method of the robotic arm system 100 could be changed according to actual need/demand; however, such exemplification not meant to be limiting.

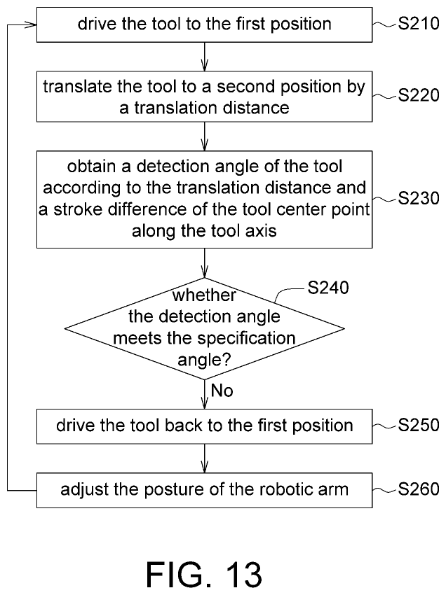

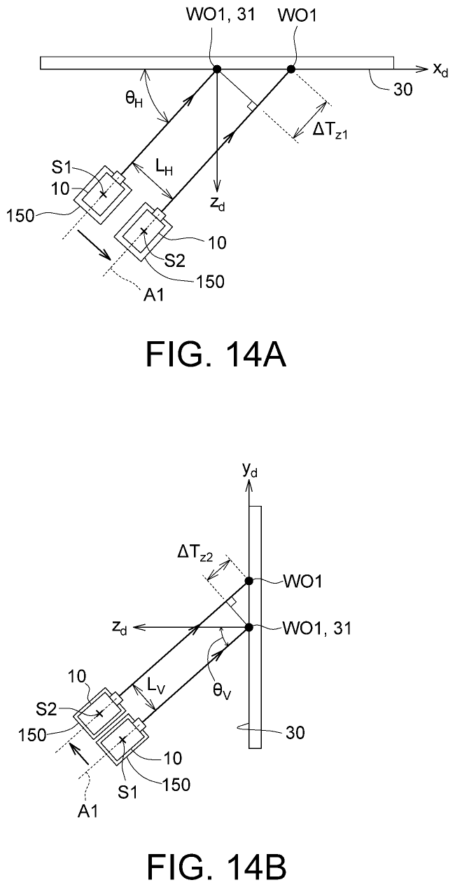

After the tool center point coordinate TP is obtained, the controller 140 could accordingly drive the robotic arm 110 to control the tool center point WO1 to a desired position. As a result, the robotic arm system 100 could perform an automatic teaching process for the robotic arm, and the following description is submitted with FIGS. 13 and 14A to 14B.

Referring to FIGS. 13 and 14A to 14B, FIG. 13 shows a flowchart of an automatic teaching method for the robotic arm system 100 according to an embodiment of the present disclosure, and FIG. 14A shows a schematic diagram of the robotic arm system 100 of FIG. 1 performing a first detection teaching process on the tool center point WO1 of the tool 10, and FIG. 14B shows a schematic diagram of the robotic arm system 100 of FIG. 1 performing a second detection teaching process on the tool center point WO1 of the tool 10.

In the following, the process of the robotic arm system 100 of FIG. 1 performing the first detection teaching process on the tool center point WO1 of the tool 10 is described using steps S210 to S260.

In step S210, as shown in FIG. 14A, the controller 140 drives the tool 10 to the first position S1 using uses the tool center point coordinate TP(Tₓ T_{y} T_{z}) and to, in the first position S1, make the tool center point WO1 coincides with a designated point 31 of a detection surface 30 (plane x_{d}-y_{d}). In detail, since the controller 140 could obtain (calculate) the tool center point coordinate TP according to the calibration point information group matrix T₃ (for example, the above formula (10)), it could control the tool center point coordinate TP of the tool 10 to move to the desired position, so that the center point coordinate TP is moved to coincide with the designated point 31 of the detection surface 30. The detection surface 30 is, for example, a display surface of a display, and the designated point 31 is, for example, any point on the detection surface 30, for example, a center point of the detection surface 30.

In step S220, as shown in FIG. 14A, the controller 140 translates the tool 10 to a second position S2 by a translation distance L_{H}. The way to translate the tool 10 is, for example, that the robotic arm system 100 further includes a moving element 150 which is slidably disposed on the robotic arm 110. The tool 10 and the light source 130 (the light source 130 not shown in FIG. 14A) could be disposed on the moving element 150 so that the tool 10 and the light source 130 could be translated with the moving element 150. In an embodiment, the controller 140 could control the moving element 150 to translate the translation distance L_{H} to synchronously drive the tool 10 to translate by the translation distance L_{H}.

In step S230, as shown in FIG. 14A, a detection angle θ_{H} of the tool 10 is obtained according to the translation distance L_{H} and a stroke difference ΔT_{Z1} (using the translation axis module of the moving element 150 in conjunction with triangulation method) of the tool center point WO1 of the tool 10 along the tool axis A1, as shown in the following formula (13). The detection angle θ_{H} is, for example, the angle between the tool axis A1 and the axis x_{d} when the tool axis A1 is projected on the x_{d}-y_{d} plane.

θ_{H}=π/2−tan⁻¹(ΔT_{Z1}/L_{H}) (13)

In step S240, the controller 140 determines whether the detection angle θ_{H} meets a first specification angle. When the detection angle θ_{H} does not meet the first specification angle, the process proceeds to step S250, and the controller 140 drives the tool 10 back to the first position S1. For example, the controller 140 could control the moving element 150 to translate for driving the tool 10 back to the first position S1. The first specification angle is, for example, specification value of the product, which is the specification value required when the tool 10 detects the detection surface 30 along the first detection direction. In detail, when the detection angle θ_{H} meets the first specification angle, analysis result of the display by the tool 10 (for example, the luminance meter) does not exceed the range (for example, when viewing display screen of the display in a skewed angle of view, a black screen or abnormal color will not be generated). The value of the first specification angle depends on the type of product, for example, the maximum viewing angle or the viewing angle of the flat-panel display; however, such exemplification not meant to be limiting.

In step S260, when the tool 10 returns to the first position, the controller 140 adjusts the posture of the robotic arm 110 to change the angle of the tool axis A1 relative to the detection surface 30, and then the process returns to step S210. The controller 140 could repeat steps S210 to S260 until the detection angle θ_{H} meets the first specification angle. For example, if the detection angle θ_{H} does not meet the first specification angle, the controller 140 controls the robotic arm 110 to rotate to rotate the tool 10 by an angle around the second axis (for example, the axis y_{d}), and then the process returns to step S210. Repeat steps S210 to S260 according to this principle until the detection angle θ_{H} meets the first specification angle.

Similarly, as shown in FIG. 14B, the robotic arm system 100 could use a similar method (using the process in FIG. 13) to perform a second detection teaching process on the tool center point WO1 of the tool 10.

For example, in step S210, as shown in FIG. 14B, the controller 140 drives the tool 10 to the first position S1 using uses the tool center point coordinate TP (Tₓ T_{y} Tₓ), and to, in the first position S1, make the tool center point WO1 coincide with the designated point 31 of the detection surface 30.

In step S220, as shown in FIG. 14B, the controller 140 translates the tool 10 to a second position S2 by a translation distance L_{V}. In an embodiment, the controller 140 could control the moving element 150 to translate by the translation distance L_{V} to synchronously drive the tool 10 to translate the translation distance L_{V}.

as shown in FIG. 14B, a detection angle θ_{V} of the tool 10 is obtained according to the translation distance L_{V} and a stroke difference ΔT_{Z2} of the tool center point WO1 of the tool 10 along the tool axis A1, as shown in the following formula (14). The detection angle θ_{V} is, for example, the angle between the tool axis A1 and the axis z_{d} when the tool axis A1 is projected on the x_{d}-y_{d} plane.

θ_{V}=tan⁻¹(ΔT_{Z2}/L_{V}) (14)

In step S240, the controller 140 determines whether the detection angle θ_{V} meets a second specification angle. When the detection angle θ_{V} does not meet the second specification angle, the process proceeds to step S250, and the controller 140 drives the tool 10 back to the second position S2. For example, the controller 140 could control the moving element 150 to translate for driving the tool 10 back to the second position S2. The second specification angle is, for example, specification value of the product, which is the specification value required when the tool 10 detects the detection surface 30 along the second detection direction. In detail, when the detection angle θ_{V} meets the second specification angle, analysis result of the display by the tool 10 (for example, the luminance meter) does not exceed the range (for example, when viewing display screen of the display in a skewed angle of view, a black screen or abnormal color will not be generated). The value of the second specification angle depends on the type of product, for example, the maximum viewing angle or the viewing angle of the flat-panel display; however, such exemplification not meant to be limiting.

In step S260, when the tool 10 returns to the first position S1, the controller 140 adjusts the posture of the robotic arm 110 to change the angle of the tool axis A1 relative to the detection surface 30, and then the process returns to step S210. The controller 140 could repeat steps S210 to S260 until the detection angle θ_{V} meets the second specification angle. For example, if the detection angle θ_{V} does not meet the second specification angle, the controller 140 controls the robotic arm 110 to rotate to rotate the tool 10 by an angle around the first axis (for example, the axis x_{d}) until the detection angle θ_{V} meets the first specification angle.

When the detection angle θ_{H} meets the first specification angle and the detection angle θ_{V} meets the second specification angle, the controller 140 records the joint coordinate combination or performs detection according to the current posture of the robotic arm 110. For example, the controller 140 records the change amount of the motion parameters of the joints J1 to J6 of the robotic arm 110 during the steps S210 to S260.

In summary, according to the robotic arm system and the calibration method using the tool center point in the embodiments of the present disclosure, even if additional sensors and measuring devices (for example, three-dimensional measurement equipment) are not used, the calibration for the tool center point and the automatic teaching for the robotic arm could be performed.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A calibration method for tool center point, comprising:
performing a step of establishing a first conversion relationship between a robotic arm reference coordinate system and a camera reference coordinate system, comprising:
driving, by a robotic arm, a projection point of a tool axis of a tool projected on a test plane to perform a relative movement relative to a reference point of the test plane; and
establishing the first conversion relationship according to the relative movement;
obtaining a tool axis vector relative to an installation surface reference coordinate system of the robotic arm;
performing a calibration point information group obtaining step, comprising:
(a1) driving, by the robotic arm, a tool center point to coincide with the reference point of the test plane, and recording a calibration point information group of the robotic arm;
(a2) driving, by the robotic arm, the tool to change an angle of the tool axis; and
(a3) repeating steps (a1) and (a2) to obtain a plurality of the calibration point information groups; and
obtaining a tool center point coordinate relative to the installation surface reference coordinate system according to the calibration point information groups.

2. The calibration method according to claim 1, wherein the step of driving, by the robotic arm, the projection point of the tool axis of the tool projected on the test plane to perform the relative movement relative to the reference point of the test plane further comprises:
driving, by the robotic arm, the tool to move by a space vector from the reference point along a plurality of axes of the robotic arm reference coordinate system;
wherein the step of establishing the first conversion relationship further comprises:
capturing, by a camera, an image of the projection point moving on the test plane;
wherein the step of establishing the first conversion relationship further comprises:
analyzing the image captured by the camera to obtain a value of a plane coordinate of each space vector; and
establishing the first conversion relationship between the robotic arm reference coordinate system and the camera reference coordinate system according to mutually orthogonal characteristics of the space vectors.

3. The calibration method according to claim 1, wherein the step of driving, by the robotic arm, the projection point of the tool axis of the tool projected on the test plane to perform the relative movement relative to the reference point of the test plane further comprises:
driving, by the robotic arm, tool to move by a first space vector from the reference point along a first axis of the robotic arm reference coordinate system;
driving, by the robotic arm, tool to move by a second space vector from the reference point along a second axis of the robotic arm reference coordinate system;
driving, by the robotic arm, tool to move by a third space vector from the reference point along a third axis of the robotic arm reference coordinate system;
wherein the step of establishing the first conversion relationship further comprises: capturing, by a camera, an image of the projection point moving on the test plane;
wherein the step of establishing the first conversion relationship further comprises:
analyzing the image captured by the camera to obtain a value of a first plane coordinate of the first space vector;
analyzing the image captured by the camera to obtain a value of a second plane coordinate of the second space vector;
analyzing the image captured by the camera to obtain a value of a third plane coordinate of the third space vector; and
establishing the first conversion relationship between the robotic arm reference coordinate system and the camera reference coordinate system according to mutually orthogonal characteristics of the first space vector, the second space vector and the third space vector.

4. The calibration method according to claim 1, wherein the step of obtaining the tool axis vector comprises:
performing offset correction to the tool axis relative to a first axis of the camera reference coordinate system, comprising:
(b1) driving the tool to move along a third axis of the camera reference coordinate system;
(b2) determining whether a position of the projection point on the test plane in the first axis of the camera reference coordinate system changes according to an image, captured by a camera, of the tool moving relative to the test plane;
(b3) when the position of the projection point on the test plane in the first axis changes, driving the tool to rotate by an angle around a second axis of the camera reference coordinate system; and
(b4) repeating steps (b1) to (b3) until a position change amount of the projection point of the test plane in the first axis of the camera reference coordinate system is substantially equal to zero.

5. The calibration method according to claim 4, wherein the step of obtaining the tool axis vector comprises:
performing offset correction to the tool axis relative to the second axis of the camera reference coordinate system when the projection point of the test plane in the first axis of the camera reference coordinate system is substantially equal to zero, comprising:
(c1) driving the tool to move along a third axis of the camera reference coordinate system;
(c2) determining whether a position of the projection point on the test plane in the second axis of the camera reference coordinate system changes according to an image, captured by the camera, of the tool moving relative to the test plane;
(c3) when the position of the projection point on the test plane in the second axis changes, driving the tool to rotate by an angle around the first axis of the camera reference coordinate system; and
(c4) repeating steps (c1) to (c3) until a position change amount of the projection point of the test plane in the second axis of the camera reference coordinate system is substantially equal to zero.

6. The calibration method according to claim 1, wherein the step of obtaining the tool axis vector relative to the installation surface reference coordinate system of the robotic arm comprises:
driving the tool axis of the tool to be perpendicular to the test plane; and
obtaining the tool axis vector according to a posture of the robotic arm when the tool axis is perpendicular to the test plane.

7. The calibration method according to claim 1, wherein the step of obtaining the tool center point coordinate comprises:
adjusting an angle of a light source so that a first light emitted by the tool and a second light emitted by the light source intersect at the tool center point;
obtaining a plurality of calibration point information groups where the tool center point coincides with the reference point under a plurality of different postures of the robotic arm;
driving the tool to move along the tool axis vector;
establishing a calibration point information group matrix according to the calibration point information groups; and
obtaining the tool center point coordinate according to the calibration point information group matrix.

8. A teaching method for robotic arm, comprises:
(d1) by using the calibration method as claimed in claim 1, obtaining the tool center point coordinate and driving the tool to a first position, so that the tool center point coincides with a designated point of a detection surface at the first position;
(d2) translating the tool by a translation distance to a second position;
(d3) obtaining a detection angle of the tool according to the translation distance and a stroke difference of the tool center point of the tool along the tool axis;
(d4) determining whether the detection angle meets a specification angle;
(d5) driving the tool back to the first position when the detection angle does not meet the specification angle; and
(d6) adjusting a posture of the robotic arm to perform steps (d2) to (d6) until the detection angle meets the specification angle.

9. A robotic arm system, comprising:
a robotic arm configured to carry a tool, wherein the tool has a tool axis;
a controller configured to:
control the robotic arm to drive a projection point of a tool axis of a tool projected on a test plane to perform a relative movement relative to a reference point of the test plane;
establish a first conversion relationship between a robotic arm reference coordinate system of the robotic arm and a camera reference coordinate system according to the relative movement;
obtain a tool axis vector relative to an installation surface reference coordinate system of the robotic arm;
perform a calibration point information group obtaining step, comprising:
(a1) controlling the robotic arm to drive a tool center point to coincide with the reference point of the test plane and recording a calibration point information group of the robotic arm;
(a2) controlling the robotic arm to drive the tool to change an angle of the tool axis; and
(a3) repeating steps (a1) and (a2) to obtain a plurality of the calibration point information groups; and
obtain a tool center point coordinate relative to the installation surface reference coordinate system according to the calibration point information groups.

10. The robotic arm system according to claim 9, further comprises:
a camera configured to capture an image of the projection point moving on the test plane;
wherein the controller is further configured to:
control the robotic arm to drive the tool to move by a space vector from the reference point along a plurality of axes of the robotic arm reference coordinate system;
analyze the image captured by the camera to obtain a value of a plane coordinate of each space vector; and
establish the first conversion relationship between the robotic arm reference coordinate system and the camera reference coordinate system according to mutually orthogonal characteristics of the space vectors.

11. The robotic arm system according to claim 9, further comprises:
a camera configured to capture an image of the projection point moving on the test plane;
wherein the controller is further configured to:
control the robotic arm to drive the tool to move by a first space vector from the reference point along a first axis of the robotic arm reference coordinate system;
control the robotic arm to drive the tool to move by a second space vector from the reference point along a second axis of the robotic arm reference coordinate system;
control the robotic arm to drive the tool to move by a third space vector from the reference point along a third axis of the robotic arm reference coordinate system;
analyze the image captured by the camera to obtain a value of a first plane coordinate of the first space vector;
analyze the image captured by the camera to obtain a value of a second plane coordinate of the second space vector;
analyze the image captured by the camera to obtain a value of a third plane coordinate of the third space vector; and
establish the first conversion relationship between the robotic arm reference coordinate system and the camera reference coordinate system according to mutually orthogonal characteristics of the first space vector, the second space vector and the third space vector.

12. The robotic arm system according to claim 9, further comprises:
a camera configured to capture an image of the projection point moving on the test plane;
wherein the controller is further configured to perform offset correction to the tool axis relative to a first axis of the camera reference coordinate system, comprising;
(b1) driving the tool to move along a third axis of the camera reference coordinate system;
(b2) determining whether a position of the projection point on the test plane in the first axis of the camera reference coordinate system changes according to an image, captured by a camera, of the tool moving relative to the test plane;
(b3) when the position of the projection point on the test plane in the first axis changes, driving the tool to rotate by an angle around a second axis of the camera reference coordinate system; and
(b4) repeating steps (b1) to (b3) until a position change amount of the projection point of the test plane in the first axis of the camera reference coordinate system is substantially equal to zero.

13. The robotic arm system according to claim 12, wherein the controller further configured to perform offset correction to the tool axis relative to the second axis of the camera reference coordinate system when the projection point of the test plane in the first axis of the camera reference coordinate system is substantially equal to zero, comprising:
(c1) driving the tool to move along a third axis of the camera reference coordinate system;
(c2) determining whether a position of the projection point on the test plane in the second axis of the camera reference coordinate system changes according to an image, captured by the camera, of the tool moving relative to the test plane;
(c3) when the position of the projection point on the test plane in the second axis changes, driving the tool to rotate by an angle around the first axis of the camera reference coordinate system; and
(c4) repeating steps (c1) to (c3) until a position change amount of the projection point of the test plane in the second axis of the camera reference coordinate system is substantially equal to zero.

14. The robotic arm system according to claim 9, wherein the controller is further configured to:
drive the tool axis of the tool to be perpendicular to the test plane; and
obtain the tool axis vector of the tool relative to the installation surface reference coordinate system of the robotic arm according to a posture of the robotic arm when the tool axis is perpendicular to the test plane.

15. The robotic arm system according to claim 9, wherein a first light emitted by the tool and a second light emitted by the light source intersect at the tool center point, and the controller is further configured to:
obtain a plurality of calibration point information groups where the tool center point coincides with the reference point under a plurality of different postures of the robotic arm;
drive the tool to move along the tool axis vector;
establish a calibration point information group matrix according to the calibration point information groups; and
obtain the tool center point coordinate according to the calibration point information group matrix.

16. The robotic arm system according to claim 9, wherein the controller is further configured to:
(d1) drive the tool to a first position, so that the tool center point coincides with a designated point of a detection surface at the first position;
(d2) translate the tool by a translation distance to a second position;
(d3) obtain a detection angle of the tool according to the translation distance and a stroke difference of the tool center point of the tool along the tool axis;
(d4) determine whether the detection angle meets a specification angle;
(d5) drive the tool back to the first position when the detection angle does not meet the specification angle; and
(d6) adjust a posture of the robotic arm to perform steps (d2) to (d6) until the detection angle meets the specification angle.
